(19) United States
(12) Patent Application Publication
(10) Pub. No.: US 2017/0092330 A1
(43) Pub. Date: Mar. 30, 2017

(54) VIDEO INDEXING METHOD AND DEVICE USING THE SAME

(71) Applicant: INDUSTRIAL TECHNOLOGY RESEARCH INSTITUTE, Hsinchu (TW)

(72) Inventors: Luo-Wei TSAI, Taipei City (TW); Kual-Zheng LEE, Puzi City (TW); Guo-Ruei CHEN, Yunlin County (TW)

(73) Assignee: INDUSTRIAL TECHNOLOGY RESEARCH INSTITUTE, Hsinchu (TW)

(21) Appl. No.: 14/943,756

(22) Filed: Nov. 17, 2015

(30) Foreign Application Priority Data
Sep. 25, 2015 (TW) 104131761

(51) Int. Cl. G11B 27/10; G06K 9/00; G06T 7/20

(52) U.S. Cl. CPC G11B 27/10; G06T 7/20; G06K 9/00335; G06K 9/00758; G06K 9/00751

(57) ABSTRACT

A video indexing method is provided. The video indexing method includes steps of: analyzing trajectory information of a plurality of objects in a video data to obtain a sequence of object snaps including a plurality of object snaps; generating a sequence of candidate object snaps by filtering off some of the object snaps according to the appearance differences between the object snaps; selecting a plurality of representative object snaps from the sequence of candidate object snaps; and generating a video indexing image by merging the selected representative object snaps into a background image.

This application claims the benefit of Taiwan application Serial No. 104131761, filed Sep. 25, 2015, the disclosure of which is incorporated by reference herein in its entirety.

### TECHNICAL FIELD

The disclosure relates in general to a video indexing method and a device using the same, and more particularly to a video indexing method which creates video indexes according to representative object snaps and a device using the same.

### BACKGROUND

Along with the increase in the density of monitoring systems, video recording has become an indispensable tool in the maintenance of law and order and is normally used after the happening of an event. However, as the density of video recorders continuously increases, it would be extremely time-consuming to manually filter a large volume of video data.

Video synopsis is a latest video indexing technology, which, through time condensation, largely reduces the redundant parts in time and space of the video data and allows the user to conveniently browse the video and intercept video data.

However, how to increase video indexing efficiency for video synopsis is still a prominent task for the industries.

### SUMMARY

The disclosure is directed to a video indexing method and a device using the same capable of extracting objects from the video data and condensing the video data into one or more video indexing images according to the representative object snap of each object. Thus, the user can quickly browse the video content, and the video indexing efficiency can be increased.

According to one embodiment, a video indexing method is provided. The video indexing method includes steps of: analyzing trajectory information of a plurality of objects in a video data to obtain a sequence of object snaps including a plurality of object snaps; generating a sequence of candidate object snaps by filtering off some of the object snaps according to the appearance differences between the object snaps; selecting a plurality of representative object snaps from the sequence of candidate object snaps; and generating a video indexing image by merging the selected representative object snaps into a background image.

According to another embodiment, a video indexing device is provided. The video indexing device includes an analysis unit, a filter unit, a determination unit and an indexing generation unit. The analysis unit is for analyzing trajectory information of a plurality of objects in a video data to obtain a sequence of object snaps including a plurality of object snaps. The filter unit is for filtering off some of the object snaps according to the appearance differences between the object snaps to generate a sequence of candidate object snaps. The determination unit is for selecting a plurality of representative object snaps from the sequence of candidate object snaps. The indexing generation unit is for merging the selected representative object snaps into a background image to generate a video indexing image.

According to an alternative embodiment, a non-transitory computer readable recording medium with built-in program is provided. After the computer has loaded in and executed the program, the computer can complete the video indexing method of the present disclosure.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a block diagram of a video indexing device according to an embodiment of the present disclosure.

FIG. 2 is a flowchart of a video indexing method according to an embodiment of the present disclosure.

FIG. 3 is a schematic diagram of an example of creating a corresponding video indexing image from the video data.

FIG. 4 is a schematic diagram of a sequence of object snaps according to an embodiment of the present disclosure.

FIG. 5 is a schematic diagram of generating a sequence of candidate object snaps from the sequence of object snaps according to an embodiment of the present disclosure.

FIG. 6 is a schematic diagram of an example of generating a video indexing image by selecting a representative object snap of each object from the sequence of candidate object snaps and further merging the selected representative object snaps.

FIG. 7 is a schematic diagram of another example of generating a video indexing image by selecting a representative object snap of each object from the sequence of candidate object snaps and further merging the selected representative object snaps.

FIG. 8 is a schematic diagram of adding representative object snaps to a video indexing image according to object density according to an embodiment of the present disclosure.

FIG. 9 is a schematic diagram of generating a background image of a video indexing image according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Some implementations of the present disclosure are disclosed in a number of embodiments with detailed descriptions and accompanying drawings. It should be noted that the structures and contents of the implementations are for exemplary purpose only, not for limiting the scope of protection of the present disclosure. The present disclosure does not disclose all possible embodiments. Any person ordinary skilled in the technology field, without violating the spirit and scope of the present disclosure, will be able to make necessary changes and modifications to the structures of the embodiments to meet actual needs. The above changes and modifications are also applicable to the implementations not disclosed in the present disclosure. Moreover, designations common to the embodiments are used to indicate identical or similar elements.

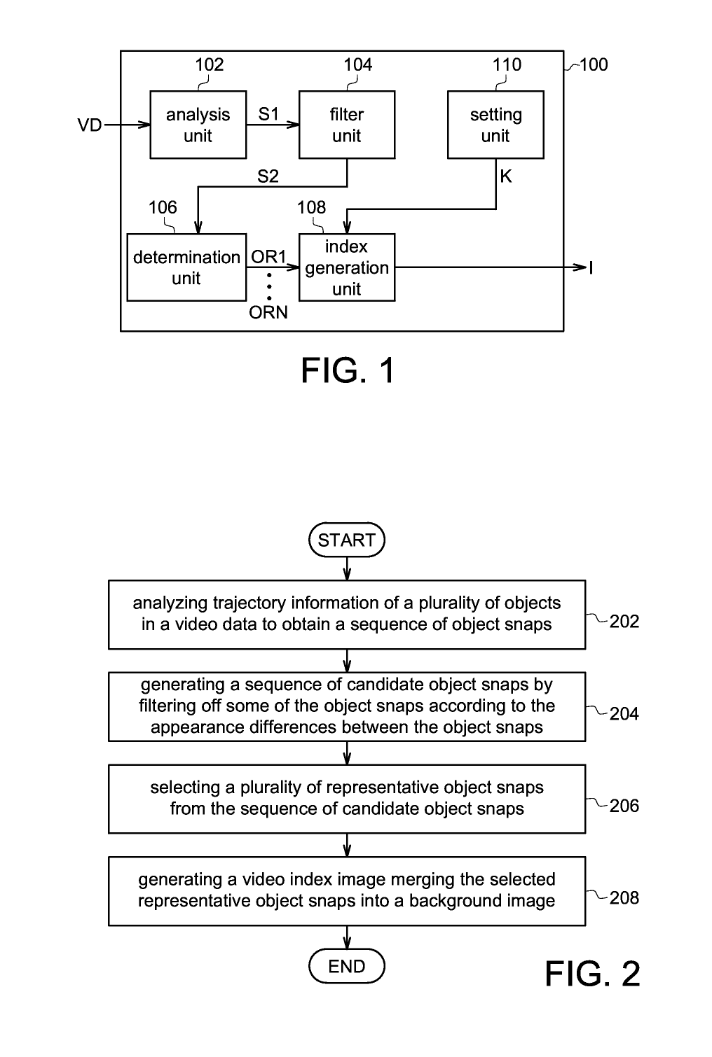

Refer to FIG. 1 and FIG. 2. FIG. 1 is a block diagram of a video indexing device 100 according to an embodiment of the present disclosure. FIG. 2 is a flowchart of a video indexing method according to an embodiment of the present disclosure. The video indexing device 100 can be realized by such as a mobile device, a PC Tablet, a personal computer, a monitoring system, or other electronic devices capable of processing video data.

The video indexing device 100 mainly includes an analysis unit 102, a filter unit 104, a determination unit 106 and an indexing generation unit 108. These units can be realized by such as an integrated circuit, a circuit board, or at least one readable programming code read from the at least one memory device by the processing unit.

In step 202, the analysis unit 102 analyzes trajectory information of a plurality of objects of the video data VD to obtain a sequence of object snaps S1, including, for example, a plurality of object snaps. The source of the video data VD is such as a video file, a video recorder of a mobile device, a network video streaming (such as YouTube), a network video recorder or a depth-of-field video recorder.

The analysis unit 102 extracts trajectory information of the objects by using the object detection and tracking algorithms. Examples of the object detection algorithm include the Gaussian mixture model (GMM) method, the temporal median filter method and the nonparametric kernel density estimation (KDE) method. Examples of the object tracking algorithm include the mean shift method, the cam shift method and the particle filter method.

For example, the analysis unit 102 creates a background image not containing any objects, and then compares the difference in each pixel between an input image and the newly created background image. If the difference is larger than a threshold, then the pixel is determined as a variant pixel, or referred as a foreground. In an embodiment, the analysis unit 102 can detect variant pixels by using a motion detection method, such asGaussians mixture model (GMM), temporal median filter or nonparametric kernel density estimation (KDE). After the variant pixels in the frame are obtained, different objects in the foreground are marked for tracking objects.

After the object detection and tracking procedure is completed, the analysis unit 102 obtains a sequence of object trajectory in the video data VD and object snaps, and further sort the object snaps to generate the sequence of object snaps S1.

In step 204, the filter unit 104 filters off some of the object snaps according to the appearance differences between the object snaps to generate a sequence of candidate object snaps S2. For example, the filter unit 104 filters the object snaps whose degrees of similarity are larger than a similarity threshold off the sequence of object snaps S1 to generate a sequence of candidate object snaps S2. In embodiments, the degrees of similarity are calculated according to at least one of the factors including object appearance, distance, motion vector and life cycle.

In step 206, the determination unit 106 selects a plurality of representative object snaps OR1˜ORN from the sequence of candidate object snaps S2. Each of the representative object snaps OR1˜ORN corresponds to an object in the video data VD.

In step 208, the indexing generation unit 108 merges the representative object snaps OR1˜ORN into a background image to generate one or more video indexing images I. In an embodiment, the analysis unit 102 analyzes a plurality of image snaps sampled from the video data and extracts a plurality of candidate background images. Then, the indexing generation unit 108 further selects one of the candidate background images as a background image.

The one or more video indexing images I generated by the indexing generation unit 108 can be shown on a screen for the user to view and analyze. For example, the user can click a representative object snap of the video indexing image I to browse the video content of the corresponding object.

In an embodiment, the video indexing device 100 further includes a setting unit 110 for determining an object density K, which can be used for determining the density of representative object snaps added to the video indexing image. For example, the indexing generation unit 108 sequentially merges representative object snaps OR1˜ORN into a background image, and outputs a video indexing image I1 when the density of representative object snaps of the background image reaches the object density K. Meanwhile, the video indexing image I1 includes K representative object snaps (such as OR1˜ORK) corresponding to K objects. Then, the representative object snaps (such as ORK+1˜ORN) having not been added to the video indexing image I1 are added to another video indexing image I2, and other values of object density K can be done in the same manner. The setting unit 110, which can be realized by such as a human-machine interface, sets the value of object density K in response to an external operation.

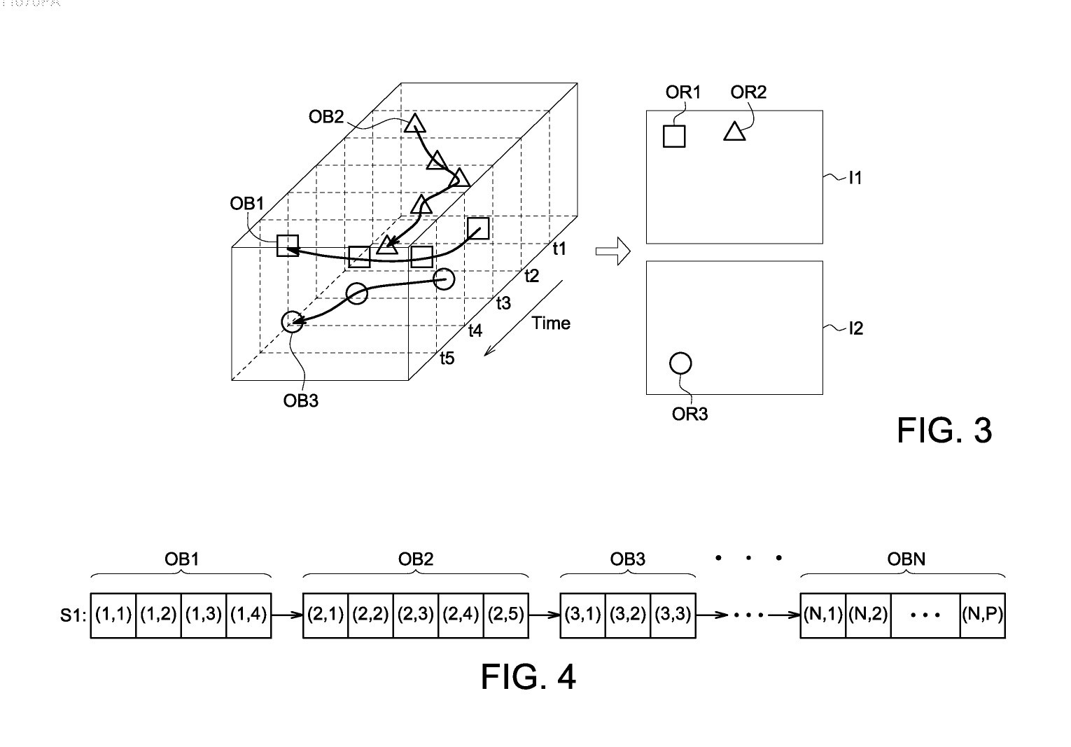

FIG. 3 is a schematic diagram of an example of creating a corresponding video indexing image from the video data VD. In the example illustrated in FIG. 3, the foreground of the video data VD includes three objects OB1, OB2, and OB3. Respective trajectory information (as indicated in arrows) of the objects OB1˜OB3 in the video data VD and the object snaps can be obtained by using an object tracking algorithm. The object snaps of the object OB1 are sampled at time points t2˜t5 respectively. The object snaps of the object OB2 are sampled at time points t1˜t5 respectively. The object snaps of the object OB3 are sampled at time points t3˜t5 respectively.

By using the method as indicated in FIG. 2, one of the object snaps of the object OB1 is selected as the representative object snap OR1 of the object OB1, one of the object snaps of the object OB2 is selected as the representative object snap OR2 of the object OB2, and one of the object snaps of the object OB3 is selected as the representative object snap OR3 of the object OB3.

Since the representative object snaps OR1, OR2, and OR3 are sampled from the trajectory corresponding to the object OB1, OB2, and OB3, the representative object snaps appearing on the same video indexing image may correspond to the object snaps sampled at different time points. As indicated in FIG. 3, the representative object snaps OR1 and OR2 in the same video indexing image I1 correspond to the object snaps sampled at time points t5 and t1 respectively.

Based on the method of adding the object snaps to the object representative object snap and/or the value of the object density K, the object snaps sampled at the same sampling time point may appear in different video indexing images. That is, the contents of different video indexing images are not restricted by the priority by which the objects appear. Let FIG. 3 be taken for example. Suppose the object density K is set as: K=2. If the representative object snaps OR1 and OR2 have been added to the video indexing image I1, then the representative object snap OR3 will be added to another video indexing image I2 despite that both representative object snaps OR1 and OR3 correspond to the object snaps sampled at time point t5.

In an embodiment, the video data VD is divided into a plurality of sub-segments, and respective video indexing image corresponding to each sub-segment is generated. Let the uninterrupted video data VD obtained from a monitor be taken for example. The uninterrupted video data VD can be divided into a plurality of sub-segments in the unit of is minutes. Then, the method illustrated in FIG. 2 is performed on each sub-segment to generate one or more corresponding video indexing images.

FIG. 4 is a schematic diagram of a sequence of object snaps S1 according to an embodiment of the present disclosure. In the example illustrated in FIG. 4, the video content of the video data VD includes objects OB1˜OBN. The symbol “(i, j)” represents the object snap of the i-th object (that is, OBi) sampled at the j-th time point, wherein 1≦i≦N. For example, the symbol “(1, 2)” represents the object snap of the object OB1 sampled at the second time point, the symbol “(2, 3)” represents the object snap of the object OB2 sampled at the third time point, and the rest can be obtained in the same manner.

The analysis unit 102 generates a sequence of object snaps S1 by sequentially arranging the object snaps related to the same object. In the sequence of object snaps S1 illustrated in FIG. 4, the object snaps (1, 1)˜(1, 4) related to object OB1, the object snaps (2, 1)˜(2, 5) related to object OB2, the object snaps (3, 1)˜(3, 3) related to object OB3, and the object snaps (N, 1)˜(N˜P) related to the object OBN all sequentially arranged one after another. However, the sequence of object snaps S1 can be generated by using other sorting methods.

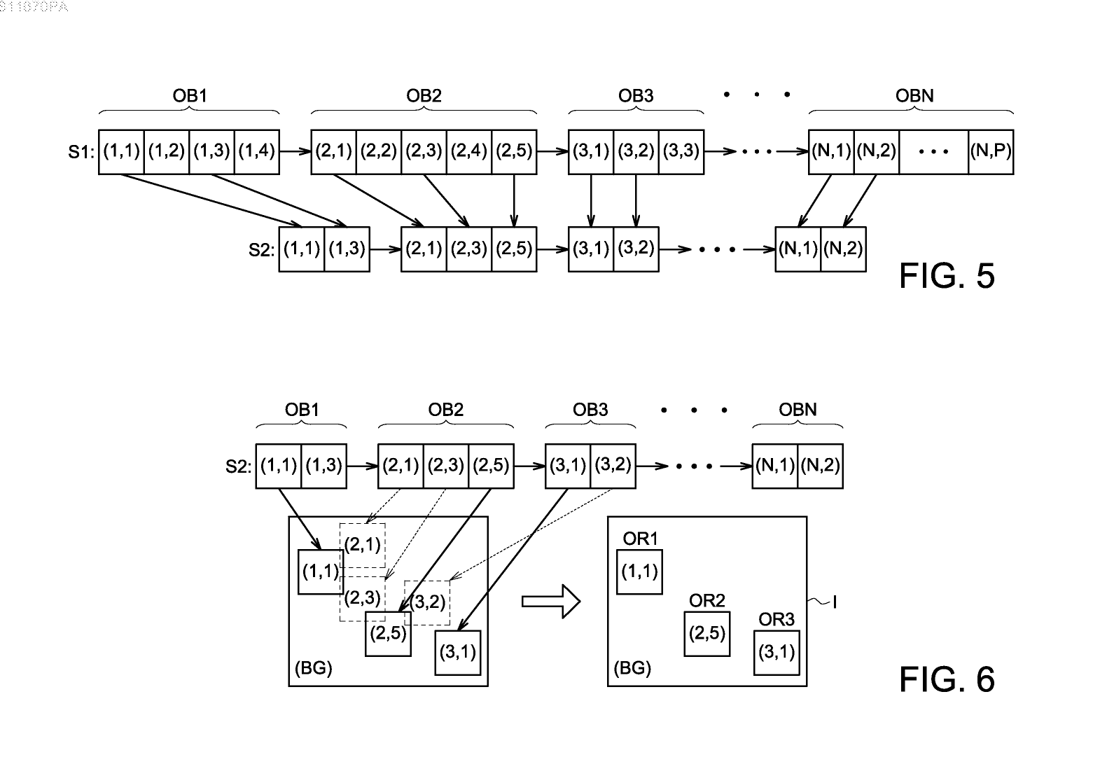

FIG. 5 is a schematic diagram of generating a sequence of candidate object snaps S2 from the sequence of object snaps S1 according to an embodiment of the present disclosure. In the example illustrated in FIG. 5, the sequence of candidate object snaps S2 is generated by filtering the object snaps (1, 2) and (1, 4) of the object OB1, the object snaps (2, 2) and (2, 4) of the object OB2, the object snaps (3, 3) of the object OB3, and the object snaps (N, 3)˜(N, P) of the object OBN off the sequence of object snaps S1. The object snaps that are filtered off the sequence of object snaps S1 have high degree of similarity.

FIG. 6 is a schematic diagram of an example of generating a video indexing image by selecting a representative object snap of each object from the sequence of candidate object snaps S2 and further merging the selected representative object snaps. In the present example, the determination unit 106 selects one of the candidate object snaps (1, 1) and (1, 3) as the representative object snap OR1 of the object OB1. For example, the candidate object snap (1, 1) is selected. Next, the determination unit 106 calculates the object overlapped rate of each of the candidate object snaps (2, 1), (2, 3) and (2, 5) of the object OB2 for the representative object snap OR1, and selects one of the candidate object snaps (2, 1), (2, 3) and (2, 5) as the representative object snap OR2 of the object OB2 according to the calculation result. As indicated in FIG. 6, the candidate object snap (2, 5) has the lowest object overlapped rate for the representative object snaps OR1, and is selected as the representative object snap OR2 of the object OB2. Similarly, the determination unit 106 calculates the object overlapped rate of each of the object snaps (3, 1) and (3, 2) for the representative object snaps OR1 and OR2, which have been added to the video indexing image, and selects one of the object snaps (3, 1) and (3, 2) having a lower object overlapped rate as the representative object snap OR3 of the object OB3. For example, the object snap (3, 1) is selected, and the remaining representative object snaps can be selected in the same manner.

In an embodiment, a new candidate object snaps ci is selected and placed at position li of the video indexing image, and the target function satisfying the minimal merging space for the candidate object snaps ci and previous object snap cj is expressed as:

G(i)=arg min_{ci}Σ_{iεQ′}Eₐ(lᵢ∩lⱼ) (Formulas 1)

Wherein, Ea (.) represents the cost of having collision when the candidate object snap is placed in the video indexing image; Q represents a set of all object snaps; Q′ represents a set of candidate object snaps, and Q′⊂Q. Each time when a new object snap is added to the video indexing image, a video indexing image with compact space is generated by using a local optimum. In another embodiment, a global optimum is added to the candidate object snap.

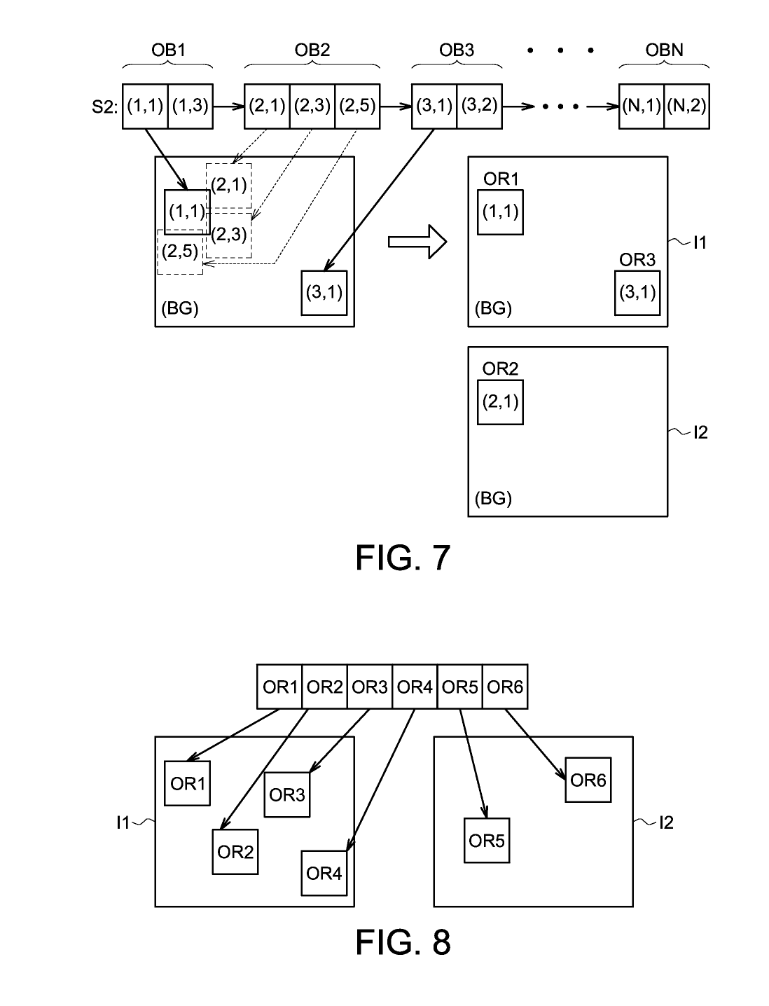

FIG. 7 is a schematic diagram of another example of generating a video indexing image by selecting a representative object snap of each object from the sequence of candidate object snaps S2 and further merging the selected representative object snaps. In the example illustrated in FIG. 7, when the object overlapped rate of each object snap of an object for the representative object snap is larger than an overlapped rate threshold, another video indexing image will be generated, and one of the object snaps of the object will be selected and shown on the another video indexing image.

Suppose the overlapped rate function of a candidate object snap ci is defined as follows:

$$\begin{matrix}AR ( i ) = {min}_{{c}_{i}} {\sum }_{i ∈ {Q}^{′}} {E}_{a} ( {l}_{i} ⋂ {l}_{j} ) / {\sum }_{i ∈ {Q}^{′}} Area ( {c}_{i} ) & ( Formulas 2 ) \\ I ( i ) = \{ \begin{matrix}{c}_{i} , & if AR ( i ) < thr\_a \\ 0 , & if otherwise\end{matrix} & ( Formulas 3 )\end{matrix}$$

Wherein, Area (ci) represents the area of the candidate object snap ci on the video indexing image; thr_a represents an overlapped rate threshold of the area overlapped rate of an object snap. If the overlapped rate of a newly added object snap is smaller than the overlapped rate threshold thr_a, then the newly added object snap can be added to the video indexing image I (i) according to its placing position. Conversely, if the overlapped rate of the newly added object snap is not smaller than the overlapped rate threshold thr_a, then the newly added object snap will not be added to the video indexing image (i) but will wait for a better space position in the next video indexing image. In an embodiment, a global area threshold thr_b can be set for each video indexing image. If the total area occupied by the currently added candidate object snaps is larger than the global area threshold thr_b, this implies that the frame is compact enough, and a next video indexing image I (i+1) can be generated.

As indicated in FIG. 7, if the object overlapped rates of the object snaps (2, 1), (2, 3), (2, 5) for the representative object snap OR1 all are larger than the overlapped rate threshold (such as the thr_a), the object snaps will not be added to the indexinging image I1, and the representative object snap OR2 of the object OB2 (such as the object snap (2, 1)) will be added to another video indexing image I2.

Since the object overlapped rate of the object snap (3, 1) of the object OB3 for the representative object snaps OR1, which has been added to the video indexing image I1 is smaller than the overlapped rate threshold, the object snap (3, 1) is selected as the object representative object snap OR3 of the object OB3 and shown on the same video indexing image I1 together with the representative object snap OR1.

The methods of adding representative object snaps of the present invention are not limited to the above exemplifications. Any time/space algorithms considering the area and/or placing position of a representative object snap when optimizing the object overlapped rate are within the spirit of the invention.

FIG. 8 is a schematic diagram of adding representative object snaps to a video indexing image according to object density K according to an embodiment of the present disclosure. The object density K is for determining the density of representative object snaps in a video indexing image. In the present example, the object density K is set as: K=4. That is, at most 4 representative object snaps can be added to a video indexing image. As indicated in FIG. 8, four representative object snaps OR1˜OR4 are sequentially added to the video indexing image I1, and the remaining representative object snaps OR5 and OR6 are added to the next video indexing image I2.

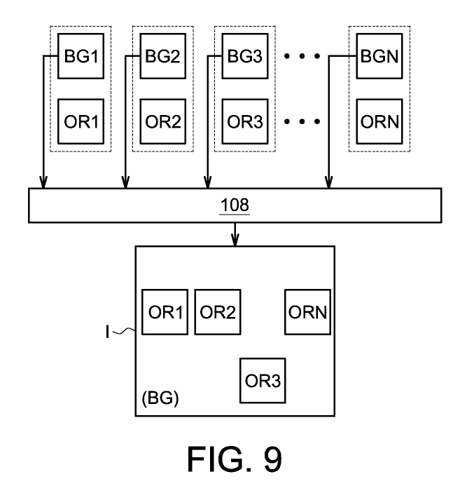

FIG. 9 is a schematic diagram of generating a background image of a video indexing image according to an embodiment of the present disclosure. In the example illustrated in FIG. 9, the indexing generation unit 108 accumulates each background image corresponding to a representative object snap, and determines the background image to be used in the video indexing image according to majority vote. Let FIG. 9 be taken for example. Suppose the candidate background images BG1 and BG2 both show a night-time scene, but the candidate background images BG3˜BGN (N>4) show a daytime scene. The indexing generation unit 108, based on the voting method, will select the daytime scene corresponding to the majority of the candidate background images as the background image BG of the video indexing image I. Then, the indexing generation unit 108 generates a video indexing image I by merging the representative object snaps OR1˜ORN into the background image BG by using the image blending method such as Possion image editing, level-set approach or Laplacian pyramids.

The present disclosure further provides a non-transitory computer readable recording medium with built-in program capable of completing the video indexing methods disclosed above after the computer loads in and executes the program.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A video indexing method, comprising:
analyzing trajectory information of a plurality of objects in a video data to obtain a sequence of object snaps comprising a plurality of object snaps;
generating a sequence of candidate object snaps by filtering off some of the object snaps according to appearance differences between the object snaps;
selecting a plurality of representative object snaps from the sequence of candidate object snaps; and
generating a video indexing image by merging the selected representative object snaps into a background image.

2. The video indexing method according to claim 1, further comprising:
generating the sequence of object snaps by sequentially arranging the object snaps related to a same object.

3. The video indexing method according to claim 1, further comprising:
generating the sequence of candidate object snaps by filtering the object snaps whose degrees of similarity are larger than a similarity threshold off the sequence of object snaps.

4. The video indexing method according to claim 3, further comprising:
calculating the similarity according to at least one of object appearance, distance, motion vector and life cycle.

5. The video indexing method according to claim 1, wherein an object overlapped rate between the representative object snaps is lower than an overlapped rate threshold.

6. The video indexing method according to claim 1, wherein the sequence of candidate object snaps comprises a plurality of first object snaps corresponding to a first object and a plurality of second object snaps corresponding to a second object, and the method further comprises:
selecting one of the first object snaps as a representative object snap of the first object;
calculating an object overlapped rate of the second object snaps for the selected first object snap; and
generating another video indexing image and selecting one of the second object snaps and adding the selected second object snap to the another video indexing image if the object overlapped rate of each of the second object snaps for the selected first object snaps is larger than an overlapped rate threshold.

7. The video indexing method according to claim 1, further comprising:
determining an object density; and
merging the selected representative object snaps into the background image, and generating the video indexing image when the density of the representative object snaps in the background image reaches the object density.

8. The video indexing method according to claim 7, further comprising:
displaying the representative object snaps not appearing on the video indexing image on another video indexing image.

9. The video indexing method according to claim 1, further comprising:
analyzing a plurality of image snaps sampled from the video data to extract a plurality of candidate background images; and
selecting one of the candidate background images as the background image.

10. A non-transitory computer readable recording medium with built-in program, wherein the non-transitory computer readable recording medium with built-in program is capable of completing the method according to claim 1 after a computer loads in and executes the program.

11. A video indexing device, comprising:
an analysis unit, analyzing trajectory information of a plurality of objects in a video data to obtain a sequence of object snaps comprising a plurality of object snaps;
a filter unit, filtering off some of the object snaps according to appearance differences between the object snaps to generate a sequence of candidate object snaps;
a determination unit, selecting a plurality of representative object snaps from the sequence of candidate object snaps; and
an indexing generation unit, merging the selected representative object snaps into a background image to generate a video indexing image.

12. The video indexing device according to claim 11, wherein the analysis unit sequentially arranges the object snaps related to a same object to generate the sequence of object snaps.

13. The video indexing device according to claim 11, wherein the filter unit filters the object snaps whose degrees of similarity are larger than a similarity threshold off the sequence of object snaps to generate the sequence of candidate object snaps.

14. The video indexing device according to claim 13, wherein the degree of similarity is calculated according to at least one of object appearance, distance, motion vector and life cycle.

15. The video indexing device according to claim 11, wherein an object overlapped rate between the representative object snaps is lower than an overlapped rate threshold.

16. The video indexing device according to claim 11, wherein the sequence of candidate object snaps comprises a plurality of first object snaps corresponding to a first object and a plurality of second object snaps corresponding to a second object, the determination unit selects one of the first object snaps as a representative object snap of the first object and calculates an object overlapped rate of the second object snaps for the selected first object snaps;
wherein, if the object overlapped rate of each of the second object snaps for the selected first object snap is larger than an overlapped rate threshold, the indexing generation unit generates another video indexing image, selects one of the second object snaps and adds the selected second object snap to the another video indexing image.

17. The video indexing device according to claim 11, further comprising:
a setting unit, determining an object density;
wherein, the indexing generation unit merges the representative object snaps into the background image, and generates the video indexing image when the density of the representative object snaps in the background image reaches the object density.

18. The video indexing device according to claim 17, wherein, the indexing generation unit displays the representative object snaps not appearing on the video indexing image on another video indexing image.

19. The video indexing device according to claim 11, wherein the analysis unit analyzes a plurality of image snaps sampled from the video data to extract a plurality of candidate background images, and the indexing generation unit selects one of the candidate background images as the background image.

20. The video indexing device according to claim 11, wherein the analysis unit, the filter unit, the determination unit and the indexing generation unit are realized by an integrated circuit or a circuit board, or realized by at least one readable programming code read from at least one memory device by a processing unit.
